(19) United States
(12) Patent Application Publication
(10) Pub. No.: US 2022/0270288 A1
(43) Pub. Date: Aug. 25, 2022

(54) SYSTEMS AND METHODS FOR POSE DETERMINATION

(71) Applicant: BEIJING VOYAGER TECHNOLOGY CO., LTD., Beijing (CN)

(72) Inventors: Xiaozhi QU, Beijing (CN); Tingbo HOU, Mountain View, CA (US); Shengsheng HAN, Beijing (CN)

(73) Assignee: BEIJING VOYAGER TECHNOLOGY CO., LTD., Beijing (CN)

(21) Appl. No.: 17/597,807

(22) PCT Filed: Jul. 25, 2019
(86) PCT No.: PCT/CN2019/097611

§ 371 Date: Jan. 24, 2022

(51) Int. Cl. G06T 7/73; G06V 20/56; G06V 10/764

(52) U.S. Cl. CPC G06T 7/74; G06V 20/588; G06V 10/764; G06T 2207/30252

(57) ABSTRACT

The present disclosure relates to a method for determining a pose of a subject. The method may include identifying a plurality of sets of data points representing a plurality of cross sections of a path from point-cloud data representative of a surrounding environment, wherein the plurality of cross sections may be perpendicular to the ground surface and distributed along a first reference direction associated with the subject. The method may also include determining a feature vector of the at least one curb based on the plurality of sets of data points, determining at least one reference feature vector of the at least one curb based on an estimated pose of the subject and a location information database, and determining the pose of the subject by updating the estimated pose of the subject.

### TECHNICAL FIELD

The present disclosure generally relates to positioning systems and methods, and specifically, to systems and methods for determining a pose of a subject automatically, e.g., in an autonomous driving context.

### BACKGROUND

Positioning technologies are widely used in various fields, such as navigation systems, e.g., navigation for autonomous driving systems. For an autonomous driving system, it is important to determine a precise pose, such as a position and/or an orientation of a subject (e.g., an autonomous vehicle). Normally, one or more sensors (e.g., a LiDAR device) may be mounted on the subject to acquire point-cloud data representative of a surrounding environment of the subject. If the subject is stopped or traveling on a path, the pose of the subject may be determined based on one or more curbs, which extend along the path and be easily detected by the sensor(s). Therefore, it is desirable to provide effective systems and methods for determining the pose of the subject according to the curb(s) in the surrounding environment, thus improving positioning accuracy and efficiency.

### SUMMARY

In a first aspect of the present disclosure, a system for determining a pose of a subject is provided. The subject may be located on a path in a surrounding environment. The path may have a ground surface and at least one curb, and each of the at least one curb may be on a side of the path and having a height. The system may include at least one storage medium including a set of instructions, and at least one processor in communication with the at least one storage medium. When executing the set of instructions, the at least one processor may direct the system to perform one or more of the following operations. A plurality of sets of data points representing a plurality of cross sections of the path may be identified from point-cloud data representative of the surrounding environment. The plurality of cross sections may be perpendicular to the ground surface and distributed along a first reference direction associated with the subject. A feature vector of the at least one curb may be determined based on the plurality of sets of data points. At least one reference feature vector of the at least one curb may be determined based on an estimated pose of the subject and a location information database. The pose of the subject may be determined by updating the estimated pose of the subject. The updating of the estimated pose may include comparing the feature vector with the at least one reference feature vector.

In some embodiments, the at least one processor may further direct the system to perform one or more of the following operations. The point-cloud data may be classified into a plurality of subgroups representing a plurality of physical objects. The plurality of physical objects may at least include the at least one curb and the ground surface. The plurality of sets of data points may be identified from the subgroup representing the at least one curb and the subgroup representing the ground surface.

In some embodiments, the at least one processor may further direct the system to perform one or more of the following operations. A classification model of data points may be obtained. The point-cloud data may be classified into the plurality of subgroups by inputting the point-cloud data into the classification model.

In some embodiments, the at least one processor may further direct the system to perform one or more of the following operations. For each cross section of the path, one or more characteristic values of the at least one curb in the cross section may be determined based on the corresponding set of data points. The feature vector of the at least one curb may be constructed based on the one or more characteristic values of the at least one curb in each cross section.

In some embodiments, the at least one curb in each cross section may include a plurality of physical points in the cross section. The one or more characteristic values of the at least one curb in each cross section may include at least one of a characteristic value related to normal angles of the corresponding physical points, a characteristic value related to intensities of the corresponding physical points, a characteristic value related to elevations of the corresponding physical points, or a characteristic value related to incidence angles of the corresponding physical points.

In some embodiments, the at least one processor may further direct the system to perform one or more of the following operations. For each of the physical points of the at least one curb in the cross section, a plurality of target data points representing an area in the cross section may be determined among the corresponding set of data points, wherein the area may cover the physical point. For each of the physical points of the at least one curb in the cross section, a surface fitting the corresponding area may be configured based on the corresponding target data points. For each of the physical points of the at least one curb in the cross section, a normal angle between a second reference direction and a normal of the corresponding surface at the physical point may be determined. A distribution of the normal angles of the physical points of the at least one curb in the cross section may be determined as one of the one or more characteristic values of the at least one curb in the cross section.

In some embodiments, the at least one processor may further direct the system to perform one or more of the following operations. Intensities of the physical points of the at least one curb in the cross section may be determined based on the corresponding set of data points. A distribution of the intensities of the physical points of the at least one curb in the cross section may be determined as one of the one or more characteristic values of the at least one curb in the cross section.

In some embodiments, the at least one processor may further direct the system to perform one or more of the following operations. The intensities of the physical points of the at least one curb in the cross section may be normalized to a predetermined range. A distribution of the normalized intensities of the physical points of the at least one curb in the cross section may be determined as one of the one or more characteristic values of the at least one curb in the cross section.

In some embodiments, the at least one processor may further direct the system to perform one or more of the following operations. A plurality of hypothetic poses of the subject may be determined based on the estimated pose of the subject. For each of the plurality of hypothetic poses of the subject, a plurality of sets of reference data points representing a plurality of reference cross sections of the path may be obtained from the location information database. The plurality of reference cross sections may be perpendicular to the ground surface and distributed along a third reference direction associated with the hypothetic pose. For each of the hypothetic poses of the subject, a reference feature vector of the at least one curb may be determined based on the corresponding sets of reference data points.

In some embodiments, the determining the pose of the subject may include one or more iterations, and each current iteration of the one or more iterations may include one or more of the following operations. For each of the plurality of hypothetic poses, a similarity degree between the feature vector and the corresponding reference feature vector may be determined in the current iteration. A probability distribution over the plurality of hypothetic poses in the current iteration may be determined based on the similarity degrees in the current iteration. The estimated pose of the subject in the current iteration may be updated based on the plurality of hypothetic poses and the probability distribution in the current iteration. Whether a termination condition is satisfied in the current iteration may be determined. In response to a determination that the termination condition is satisfied in the current iteration, the updated pose of the subject in the current iteration may be designated as the pose of the subject.

In some embodiments, each current iteration of the one or more iterations may further include one or more of the following operations. In response to a determination that the termination condition is not satisfied in the current iteration, the plurality of hypothetic poses in the current iteration may be updated. For each of the updated hypothetic poses in the current iteration, an updated reference feature vector of the at least one curb in the current iteration may be determined. The plurality of updated hypothetic poses in the current iteration may be designated as the plurality of hypothetic poses in a next iteration. The plurality of updated reference feature vectors in the current iteration may be designated as the plurality of reference feature vectors in the next iteration.

In some embodiments, the determining the pose of the subject may be performed a particle filtering technique.

In some embodiments, the plurality of cross sections of the path may be evenly distributed along the first reference direction.

In some embodiments, the pose of the subject may include at least one of a position of the subject or an orientation of the subject.

In some embodiments, the at least one processor may further direct the system to perform one or more of the following operations. Pose data of the subject may be received from the at least one positioning device assembled on the subject. The estimated pose of the subject may be determined based on the data.

In a second aspect of the present disclosure, a method for determining a pose of a subject is provided. The subject may be located on a path in a surrounding environment. The path may have a ground surface and at least one curb, and each of the at least one curb may be on a side of the path and having a height. The method may include identifying a plurality of sets of data points representing a plurality of cross sections of the path from point-cloud data representative of the surrounding environment, wherein the plurality of cross sections may be perpendicular to the ground surface and distributed along a first reference direction associated with the subject. The method may also include determining a feature vector of the at least one curb based on the plurality of sets of data points. The method may further include determining at least one reference feature vector of the at least one curb based on an estimated pose of the subject and a location information database, and determining the pose of the subject by updating the estimated pose of the subject. The updating of the estimated pose may include comparing the feature vector with the at least one reference feature vector.

In a third aspect of the present disclosure, a non-transitory computer readable medium is provided. The non-transitory computer readable medium may comprise at least one set of instructions for determining a pose of a subject, the at least one set of instructions, when executed by at least one processor of an electrical device, the at least one processor may be directed to perform a method. The subject may be located on a path in a surrounding environment. The path may have a ground surface and at least one curb, and each of the at least one curb may be on a side of the path and having a height. The method may include identifying a plurality of sets of data points representing a plurality of cross sections of the path from point-cloud data representative of the surrounding environment, wherein the plurality of cross sections may be perpendicular to the ground surface and distributed along a first reference direction associated with the subject. The method may also determining a feature vector of the at least one curb based on the plurality of sets of data points, and determining at least one reference feature vector of the at least one curb based on an estimated pose of the subject and a location information database. The method may further include determining the pose of the subject by updating the estimated pose of the subject, wherein the updating of the estimated pose may include comparing the feature vector with the at least one reference feature vector.

In a fourth aspect of the present disclosure, a system for determining a pose of a subject is provided. The subject may be located on a path in a surrounding environment. The path may have a ground surface and at least one curb, and each of the at least one curb may be on a side of the path and having a height. The system may include an identification module, a feature vector determination module, and a pose determination module. The identification module may be configured to identify a plurality of sets of data points representing a plurality of cross sections of the path from point-cloud data representative of the surrounding environment. The plurality of cross sections may be perpendicular to the ground surface and distributed along a first reference direction associated with the subject. The feature vector determination module may be configured to determine a feature vector of the at least one curb based on the plurality of sets of data points, and to determine at least one reference feature vector of the at least one curb based on an estimated pose of the subject and a location information database. The pose determination module may be configured to determine the pose of the subject by updating the estimated pose of the subject, wherein the updating of the estimated pose including comparing the feature vector with the at least one reference feature vector.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic diagram illustrating an exemplary autonomous driving system according to some embodiments of the present disclosure;

FIG. 1B is a schematic diagram illustrating an exemplary cross section of a path on which a vehicle is located according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing device according to some embodiments of the present disclosure;

FIG. 5 is a flowchart illustrating an exemplary process for determining a pose of a subject according to some embodiments of the present disclosure;

FIG. 6 is a flowchart illustrating an exemplary process for determining a characteristic value of one or more curbs in a cross section of a path according to some embodiments of the present disclosure;

FIG. 7 is a flowchart illustrating an exemplary process for determining a characteristic value of one or more curbs in a cross section of a path according to some embodiments of the present disclosure; and

FIG. 8 is a flowchart illustrating an exemplary process for determining a pose of a subject according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “device,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, a device, or a portion thereof.

It will be understood that when a unit, device, module or block is referred to as being “on,” “connected to,” or “coupled to,” another unit, device, module, or block, it may be directly on, connected or coupled to, or communicate with the other unit, device, module, or block, or an intervening unit, device, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding determining a pose of a subject (e.g., an autonomous vehicle) in an autonomous driving system. It should be understood that this is only one exemplary embodiment. The systems and methods of the present disclosure may be applied to any other kind of transportation system. For example, the systems and methods of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, or the like, or any combination thereof.

An aspect of the present disclosure relates to systems and methods for determining a pose of a subject. The pose of the subject may include a position and/or an orientation (e.g., a heading direction) of the subject. In some embodiments, the pose of the subject includes the position and the orientation of the subject. The subject may be located on a path in a surrounding environment, and the path may have a ground surface and one or more curbs. Each of the curb(s) may be on a side of the path and have a height. The systems and methods may identify a plurality of sets of data points representing a plurality of cross sections of the path from point-cloud data representative of the surrounding environment. The plurality of cross sections may be perpendicular to the ground surface and distributed along a first reference direction associated with the subject. The systems and methods may also determine a feature vector of the curb(s) based on the plurality of sets of data points. The systems and methods may also determine at least one reference feature vector of the curb(s) based on an estimated pose of the subject and a location information database. Further, the systems and methods may determine the pose of the subject by updating the estimated pose of the subject, wherein the feature vector may be compared with the at least one reference feature vector in updating the estimated pose.

According to some embodiments of the present disclosure, the pose of the subject may be determined based on the feature vector of the curb(s). The feature vector of the curb(s) may be constructed based on one or more characteristic values of the curb(s) in the plurality of cross sections of the path. The cross sections of the path distributed along the first reference direction may represent a portion of the path in a 3D space. Accordingly, the feature vector may represent features of the curb(s) in the 3D space. Compared with a feature vector representing features of the curb(s) in a 2D space (e.g., in a single cross section of the path), the feature vector disclosed herein can more accurately reflect the features of the curb(s), thereby improving positioning accuracy and efficiency.

In addition, in certain embodiments, the curb(s) in each cross section may include a plurality of physical points on the cross section. The characteristic value(s) of the curb(s) in each cross section may be determined based on feature values of the corresponding physical points, and used in the construction of the feature vector of the curb(s). This can improve computational efficiency and reduce processing time compared with constructing the feature vector directly using the feature values of the physical points of the curb(s) in each cross section. In this way, the systems and methods of the present disclosure may help to determine the pose of the subject more efficiently and accurately.

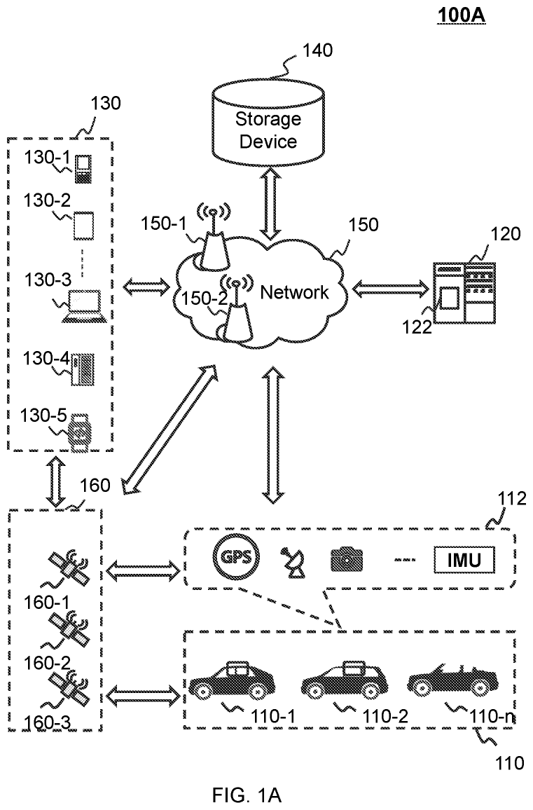

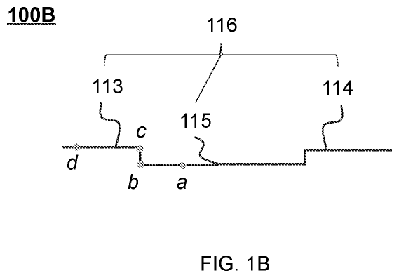

FIG. 1A is a block diagram illustrating an exemplary autonomous driving system according to some embodiments of the present disclosure. For example, the autonomous driving system 100A may provide a plurality of services such as positioning and navigation. In some embodiments, the autonomous driving system 100A may be applied to different autonomous or partially autonomous systems including but not limited to autonomous vehicles, advanced driver assistance systems, robots, intelligent wheelchairs, or the like, or any combination thereof. In a partially autonomous system, some functions can optionally be manually controlled (e.g., by an operator) some or all of the time. Further, a partially autonomous system can be configured to switch between a fully manual operation mode, a partially-autonomous, and/or a fully-autonomous operation mode. The autonomous or partially autonomous system may be configured to operate for transportation, operate for map data acquisition, or operate for sending and/or receiving an express. For illustration, FIG. 1A takes an autonomous driving system as an example. As shown in FIG. 1A, the autonomous driving system 100A may include a vehicle 110 (vehicle 110-1, 110-2 . . . and/or 110-n), a server 120, a terminal device 130, a storage device 140, a network 150, and a navigation system 160 (also referred to as a positioning system).

The vehicle 110 may carry a passenger and travel to a destination. In some embodiments, the vehicle 110 may be an autonomous vehicle. The autonomous vehicle may refer to a vehicle that is capable of achieving a certain level of driving automation. Exemplary levels of driving automation may include a first level at which the vehicle is mainly supervised by a human and has a specific autonomous function (e.g., autonomous steering or accelerating), a second level at which the vehicle has one or more advanced driver assistance systems (ADAS) (e.g., an adaptive cruise control system, a lane-keep system) that can control the braking, steering, and/or acceleration of the vehicle, a third level at which the vehicle is able to drive autonomously when one or more certain conditions are met, a fourth level at which the vehicle can operate without human input or oversight but still is subject to some constraints (e.g., be confined to a certain area), a fifth level at which the vehicle can operate autonomously under all circumstances, or the like, or any combination thereof.

In some embodiments, the vehicle 110 may be an electric vehicle, a fuel cell vehicle, a hybrid vehicle, a conventional internal combustion engine vehicle, or any other type of vehicle. The vehicle 110 may be a sports vehicle, a coupe, a sedan, a pick-up truck, a station wagon, a sports utility vehicle (SUV), a minivan, a conversion van, or have any other style. The vehicle 110 may include one or more similar components as a conventional vehicle, for example, a chassis, a suspension, a steering device (e.g., a steering wheel), a brake device (e.g., a brake pedal), an accelerator, etc. Merely by way of example, the vehicle 110 may have a body and at least one wheel, e.g., a pair of front wheels and a pair of rear wheels. The vehicle 110 may be all-wheel drive (AWD), front wheel drive (FWR), or rear wheel drive (RWD). In some embodiments, the vehicle 110 may be operated by an operator occupying the vehicle, under a remote control, and/or autonomously. In some embodiments, the vehicle 110 may be a survey vehicle configured to acquire data for constructing a high-definition (HD) map or three-dimensional (3D) city model.

As illustrated in FIG. 1A, the vehicle 110 may be equipped with one or more sensors 112 such that the vehicle 110 is capable of sensing its surrounding environment. The sensor(s) 112 may be mounted on the vehicle 110 using any suitable mounting mechanism. The mounting mechanism may be an electro-mechanical device installed or otherwise attached to the body of the vehicle 110. For example, the mounting mechanism may use one or more screws, adhesives, or another mounting mechanism. The sensor(s) 112 may be mounted on any position of the vehicle 110, for example, inside or outside the body of the vehicle.

The sensor(s) 112 of the vehicle 110 may include any sensor that is capable of collecting information related to a surrounding environment of the vehicle 110. For example, the sensor(s) 112 may include a camera, a radar unit, a GPS device, an inertial measurement unit (IMU) sensor, a light detection and ranging (LiDAR) device, or the like, or any combination thereof. The radar unit may utilize radio signals to sense objects within the surrounding environment of the vehicle 110. In some embodiments, in addition to sensing the objects, the radar unit may be configured to sense the speed and/or heading of the objects. The camera may be configured to obtain one or more images of objects (e.g., a person, an animal, a tree, a roadblock, a building, or a vehicle) that are within the scope of the camera. The camera may be a still camera or a video camera. The GPS device may refer to a device that is capable of receiving geo-location and time information from GPS satellites and then to calculate the device's geographical position. The IMU sensor may be configured to measure and provide a vehicle's specific force, angular rate, and sometimes the magnetic field surrounding the vehicle 110, using one or more inertial sensors, such as an accelerometer and a gyroscope, sometimes also magnetometers. The LiDAR device may be configured to scan the surrounding environment and acquire point-cloud data representative of the surrounding environment. For example, the LiDAR device may measure a distance to an object in the surrounding environment by illuminating the object with light pulses and measuring the reflected pulses. Differences in light return times and wavelengths may then be used to construct a 3D representation of the object. The light pulses used by the LiDAR device may be ultraviolet, visible, near infrared, etc.

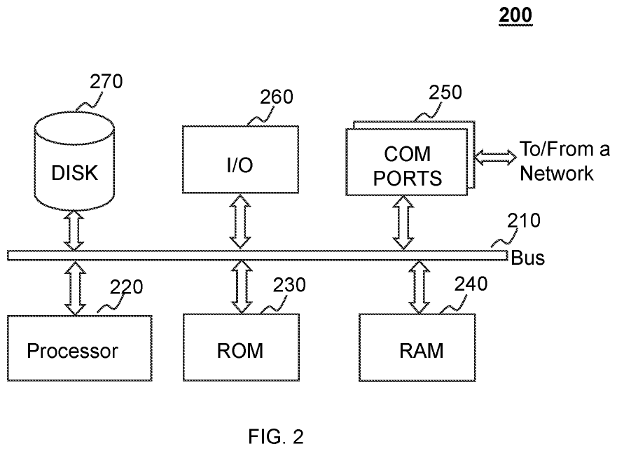

In some embodiments, the GPS device and the IMU sensor, can provide real-time pose information of the vehicle 110 as it travels. The pose information may include a position (e.g., a longitude, a latitude, and/or an elevation) of the vehicle 110 and/or an orientation (e.g., Euler angles) of the vehicle 110. However, in certain embodiments, due to performance limitations, the pose information collected by the GPS device and the IMU sensor can only provide a roughly estimated pose rather than a precise pose of the vehicle 110. The autonomous driving system 100A may need to determine the pose of the vehicle 110 based on the pose information collected by the GPS device and the IMU sensor in combination with the point-cloud data collected by the LiDAR device. According to some embodiments of the present disclosure, the vehicle 110 may be located on a path (e.g., a path 116 as shown in FIG. 2) in the surrounding environment. The path may include one or more curbs. The autonomous driving system 100A may determine the pose of the vehicle 110 based on information of the curb(s) collected by the LiDAR device.

In some embodiments, the server 120 may be a single server or a server group. The server group may be centralized or distributed (e.g., the server 120 may be a distributed system). In some embodiments, the server 120 may be local or remote. For example, the server 120 may access information and/or data stored in the terminal device 130, the sensor(s) 112, the vehicle 110, the storage device 140, and/or the navigation system 160 via the network 150. As another example, the server 120 may be directly connected to the terminal device 130, the sensor(s) 112, the vehicle 110, and/or the storage device 140 to access stored information and/or data. In some embodiments, the server 120 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 120 may be implemented on a computing device 200 having one or more components illustrated in FIG. 2 in the present disclosure.

In some embodiments, the server 120 may include a processing device 122. The processing device 122 may process information and/or data associated with the vehicle 110 to perform one or more functions described in the present disclosure. For example, the processing device 122 may determine a pose of the vehicle 110 according to data associated with a surrounding environment collected by the sensor(s) 112, especially data associated with one or more curbs in the surrounding environment. Particularly, in certain embodiments, the sensor(s) 112 may continuously or intermittently (e.g., periodically or irregularly) collect data associated with the surrounding environment when the vehicle 110 moves. The processing device 122 may determine the pose of the vehicle 110 in real-time or intermittently (e.g., periodically or irregularly). In some embodiments, the processing device 122 may include one or more processing devices (e.g., single-core processing device(s) or multi-core processor(s)). Merely by way of example, the processing device 122 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 120 may be connected to the network 150 to communicate with one or more components (e.g., the terminal device 130, the sensor(s) 112, the vehicle 110, the storage device 140, and/or the navigation system 160) of the autonomous driving system 100A. In some embodiments, the server 120 may be directly connected to or communicate with one or more components (e.g., the terminal device 130, the sensor(s) 112, the vehicle 110, the storage device 140, and/or the navigation system 160) of the autonomous driving system 100A. In some embodiments, the server 120 may be integrated into the vehicle 110. For example, the server 120 may be a computing device (e.g., a computer) installed in the vehicle 110.

In some embodiments, the terminal device 130 may enable a user interaction between a user (e.g., a driver of the vehicle 110) and one or more components of the autonomous driving system 100A. The terminal device 130 include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the server 120 may be integrated into the terminal device 130.

The terminal device 130 may be configured to facilitate interactions between a user and the vehicle 110. For example, the user may send a service request for using the vehicle 110. As another example, the terminal device 130 may receive information (e.g., a real-time position, an availability status) associated with the vehicle 110 from the vehicle 110. The availability status may indicate whether the vehicle 110 is available for use. As still another example, the terminal device 130 may be a device with positioning technology for locating the position of the user and/or the terminal device 130, such that the vehicle 10 may be navigated to the position to provide a service for the user (e.g., picking up the user and traveling to a destination). In some embodiments, the owner of the terminal device 130 may be someone other than the user of the vehicle 110. For example, an owner A of the terminal device 130 may use the terminal device 130 to transmit a service request for using the vehicle 110 for the user or receive a service confirmation and/or information or instructions from the server 120 for the user.

The storage device 140 may store data and/or instructions. In some embodiments, the storage device 140 may store data obtained from the terminal device 130, the sensor(s) 112, the vehicle 110, the navigation system 160, the processing device 122, and/or an external storage device. For example, the storage device 140 may store point-cloud data acquired by the sensor(s) 112 during a time period. As another example, the storage device 140 may store a pre-built HD map of an area (e.g., a country, a city, a street) and/or feature information of the area (e.g., one or more reference feature vectors of a curb in the area). In some embodiments, the storage device 140 may store data and/or instructions that the server 120 may execute or use to perform exemplary methods described in the present disclosure. For example, the storage device 140 may store instructions that the processing device 122 may execute or use to determine a pose of the vehicle 110.

In some embodiments, the storage device 140 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 150 to communicate with one or more components (e.g., the server 120, the terminal device 130, the sensor(s) 112, the vehicle 110, and/or the navigation system 160) of the autonomous driving system 100A. One or more components of the autonomous driving system 100A may access the data or instructions stored in the storage device 140 via the network 150. In some embodiments, the storage device 140 may be directly connected to or communicate with one or more components (e.g., the server 120, the terminal device 130, the sensor(s) 112, the vehicle 110, and/or the navigation system 160) of the autonomous driving system 100A. In some embodiments, the storage device 140 may be part of the server 120. In some embodiments, the storage device 140 may be integrated into the vehicle 110.

The network 150 may facilitate the exchange of information and/or data. In some embodiments, one or more components (e.g., the server 120, the terminal device 130, the sensor(s) 112, the vehicle 110, the storage device 140, or the navigation system 160) of the autonomous driving system 100A may send information and/or data to other component(s) of the autonomous driving system 100A via the network 150. For example, the server 120 may receive point-cloud data from the sensor(s) 112 via the network 150. In some embodiments, the network 150 may be any type of wired or wireless network, or combination thereof. Merely by way of example, the network 150 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 150 may include one or more network access points. For example, the network 150 may include wired or wireless network access points, through which one or more components of the autonomous driving system 100A may be connected to the network 150 to exchange data and/or information.

The navigation system 160 may determine information associated with an object, for example, one or more of the terminal device 130, the vehicle 110, etc. In some embodiments, the navigation system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 160 may include one or more satellites, for example, a satellite 160-1, a satellite 160-2, and a satellite 160-3. The satellites 170-1 through 170-3 may determine the information mentioned above independently or jointly. The navigation system 160 may send the information mentioned above to the network 150, the terminal device 130, or the vehicle 110 via wireless connections.

It should be noted that the autonomous driving system 100A is merely provided for the purposes of illustration, and is not intended to limit the scope of the present disclosure. For persons having ordinary skills in the art, multiple variations or modifications may be made under the teachings of the present disclosure. For example, the autonomous driving system 100A may further include one or more additional components, such as an information source, a location information database (as an independent part of the autonomous driving system 100A or be integrated into the storage device 140). As another example, one or more components of the autonomous driving system 100A may be omitted or be replaced by one or more other devices that can realize similar functions. In some embodiments, the GPS device may be replaced by another positioning device, such as BeiDou. However, those variations and modifications do not depart from the scope of the present disclosure.

FIG. 1B is a schematic diagram illustrating an exemplary cross section of an exemplary path on which a vehicle is located according to some embodiments of the present disclosure.

As shown in FIG. 1B, a path 116 may include a left curb 113, a right curb 114, and a ground surface 115. Each of the left curb 113 and the right curb 114 may be located on a side of the ground surface 115 and have a height with respect to the ground surface 115. In some embodiments, each of the left curb 113 and the right curb 114 may include a first portion abut to the ground surface 115 (e.g., a surface perpendicular to the ground surface 115) and a second portion off the ground surface 115 (e.g., a portion that forms or abuts to a sidewalk (not shown in FIG. 1B)). Taking the left curb 113 as an example, as shown in FIG. 1B, the left curb 113 may include a first surface extending from a physical point b to a physical point c and a second surface extending from the physical point c to a physical point d. In certain embodiments, the left curb 113 and/or the right curb 114 may further include a portion of the ground surface. Taking the left curb 113 as an example, a portion of the ground surface 115 extending from a physical point a to the physical point b as shown in FIG. 1B may be regarded as a portion of the left curb 113.

In some embodiments, the path 116 may include only one of the left curb 113 and the right curb 114. In some embodiments, the path 116, including the left and right curbs and the ground surface 115, may extend along a specific extension direction. Additionally or alternatively, there may be one or more physical objects other than a curb, such as a road median (e.g., a greenbelt), that form a step structure on a side of the path 116 and extend along the extension direction. For the convenience of descriptions, the term “curb” is used herein to collectively refer to physical objects that form a step structure on a side of the path 116 and extend along the extension direction of the path 116.

In some embodiments, the cross section 100B may be perpendicular to the ground surface 115. The vehicle (e.g., the vehicle 110) may stop on or travel along the path 116. A plurality of cross sections like the cross section 100B may be identified and used in determining a pose of the vehicle. For example, one or more characteristic values of the left and right curbs in each identified cross section may be determined and used to construct a feature vector of the left and right curbs. The pose of the vehicle may be determined based on the feature vector of the left and right curbs.

FIG. 2 is a schematic diagram illustrating exemplary hardware and software components of a computing device 200 according to some embodiments of the present disclosure. The computing device 200 may be used to implement any component of the autonomous driving system 100A as described herein. For example, the server 120 (e.g., the processing device 122) and/or the terminal device 130 may be implemented on the computing device 200, via its hardware, software program, firmware, or a combination thereof. Although only one such computing device is shown, for convenience, the computer functions relating to the autonomous driving system 100A as described herein may be implemented in a distributed fashion on a number of similar platforms, to distribute the processing load.

As illustrated in FIG. 2, the computing device 200 may include a communication bus 210, a processor 220, a storage device, an input/output (I/O) 260, and a communication port 250. The processor 220 may execute computer instructions (e.g., program code) and perform functions of one or more components of the autonomous driving system 100A in accordance with techniques described herein. For example, the processor 220 may determine a pose of the vehicle 110. The computer instructions may include, for example, routines, programs, objects, components, data structures, procedures, modules, and functions, which perform particular functions described herein. In some embodiments, the processor 220 may include interface circuits and processing circuits therein. The interface circuits may be configured to receive electronic signals from the communication bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the communication bus 210.

In some embodiments, the processor 220 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor 220 is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage device may store data/information related to the autonomous driving system 100A. In some embodiments, the storage device may include a mass storage device, a removable storage device, a volatile read-and-write memory, a random access memory (RAM) 240, a read-only memory (ROM) 230, a disk 270, or the like, or any combination thereof. In some embodiments, the storage device may store one or more programs and/or instructions to perform exemplary methods described in the present disclosure. For example, the storage device may store a program for the processor 220 to execute.

The I/O 260 may input and/or output signals, data, information, etc. In some embodiments, the I/O 260 may enable a user interaction with the computing device 200. In some embodiments, the I/O 260 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 250 may be connected to a network (e.g., the network 120) to facilitate data communications. The communication port 250 may establish connections between the computing device 200 and one or more components of the autonomous driving system 100A. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 250 may be and/or include a standardized communication port, such as RS232, RS485, etc. In some embodiments, the communication port 250 may be a specially designed communication port.

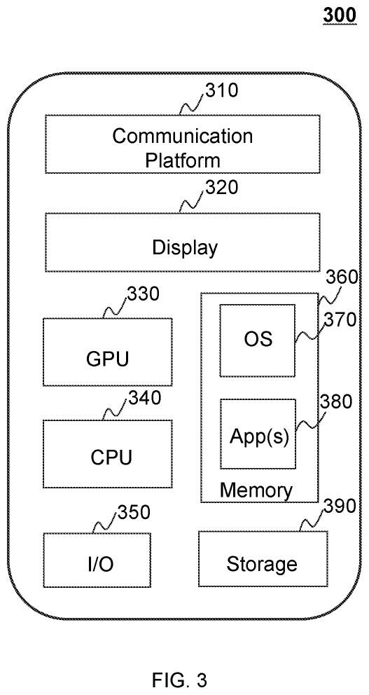

FIG. 3 is a schematic diagram illustrating exemplary hardware and/or software components of an exemplary mobile device 300 according to some embodiments of the present disclosure. In some embodiments, one or more components (e.g., the terminal device(s) 130, the processing device 122) of the autonomous driving system 100A may be implemented on the mobile device 300.

As illustrated in FIG. 3, the mobile device 300 may include a communication platform 310, a display 320, a graphics processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to positioning or other information from the processing device 122. User interactions with the information stream may be achieved via the I/O 350 and provided to the processing device 122 and/or other components of the autonomous driving system 100A via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

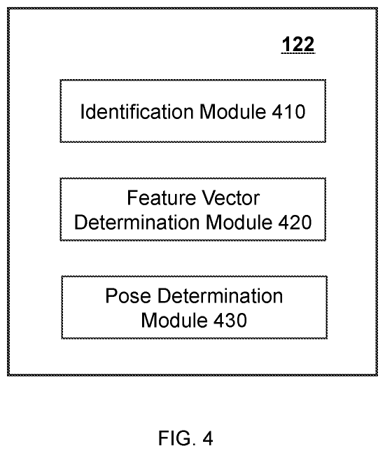

FIG. 4 is a block diagram illustrating an exemplary processing device according to some embodiments of the present disclosure. As shown in FIG. 4, the processing device 122 may include an identification module 410, a feature vector determination module 420, and a pose determination module 430.

In some embodiments, the processing device 122 may be configured to determine a pose of a subject. The subject may be located in a path (e.g., the path 116 as shown in FIG. 1B) in a surrounding environment. The path may have a ground surface and one or more curb(s). Each of the curb(s) may be on a side of the path and have a height with respect to the ground surface. The identification module 410 may be configured to identify a plurality of sets of data points representing a plurality of cross sections of the path from point-cloud data representative of the surrounding environment. In some embodiments, the identification module 410 may identify the sets of data points by classifying the point-cloud data into a plurality of subgroups, each of which represents a physical object (e.g., the curb, the ground surface, etc.). More descriptions of the identification of the plurality of sets of data points may be found elsewhere in the present disclosure (e.g., operation 510 and the descriptions thereof).

The feature vector determination module 420 may be configured to determine a feature vector of the curb(s) based on the plurality of sets of data points. The feature vector of the curb(s) may include one or more characteristic values of the curb(s). In some embodiments, for each cross section of the path, the feature vector determination module 420 may determine one or more characteristic values of the curb(s) in the cross section based on the set of data points representative of the cross section. The feature vector determination module 420 may further construct the feature vector of the curb(s) based on the one or more characteristic values of the curb(s) in each cross section. More descriptions of the determination of the feature vector of the curb(s) may be found elsewhere in the present disclosure (e.g., operation 520 and the descriptions thereof).

The feature vector determination module 420 may also be configured to determine at least one reference feature vector of the curb(s) based on an estimated pose of the subject and a location information database. The estimated pose of the subject may be obtained from one or more positioning devices (e.g., a GPS or an IMU sensor) assembled on the subject or be determined based on pose data of the subject acquired by the positioning device(s). The location information database may include any database that includes location information of a region (a country or city) covering the surrounding environment of the subject. More descriptions of the determination of the at least one reference feature vector of the curb may be found elsewhere in the present disclosure (e.g., operation 530 and the descriptions thereof).

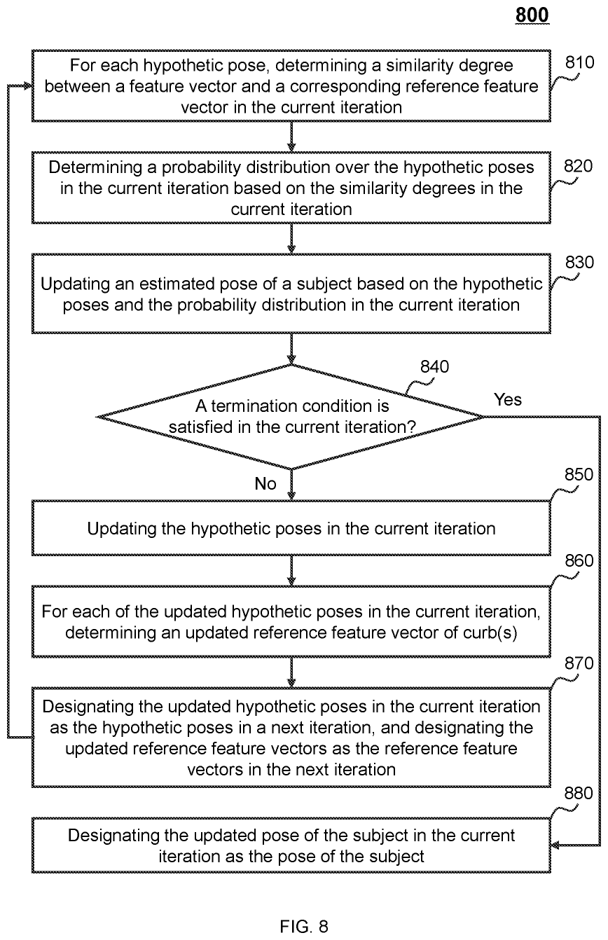

The pose determination module 430 may be configured to determine the pose of the subject by updating the estimated pose of the subject. In certain embodiments, the updating of the estimated pose may include comparing the feature vector with the at least one reference feature vector of the curb(s). For example, the pose determination module 430 may determine a similarity degree between the feature vector and each of the reference feature vectors. The pose determination module 430 may further update the estimated pose based on the similarity degrees. In certain embodiments, the pose determination module 430 may determine the pose of the subject by performing one or more iterations as described in connection with FIG. 8. More descriptions regarding the determination of the pose of the subject may be found elsewhere in the present disclosure (e.g., operation 540 and relevant descriptions thereof).

In some embodiments, the modules may be hardware circuits of all or part of the processing device 122. The modules may also be implemented as an application or set of instructions read and executed by the processing device 122. Further, the modules may be any combination of the hardware circuits and the application/instructions. For example, the modules may be part of the processing device 122 when the processing device 122 is executing the application/set of instructions.

It should be noted that the above description of the processing device 122 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be implemented in two or more separate units.

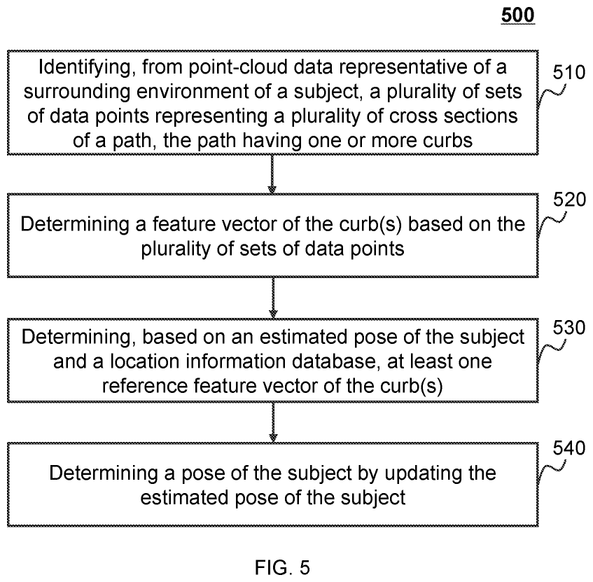

FIG. 5 is a flowchart illustrating an exemplary process for determining a pose of a subject according to some embodiments of the present disclosure. At least a portion of process 500 may be implemented on the computing device 200 as illustrated in FIG. 2. In some embodiments, one or more operations of process 500 may be implemented in the autonomous driving system 100A as illustrated in FIG. 1A. In some embodiments, one or more operations in the process 500 may be stored in a storage device (e.g., the storage device 140, the ROM 230, the RAM 240) as a form of instructions, and invoked and/or executed by the processing device 122 (e.g., the processor 220 of the computing device 200, the CPU 340 of the mobile device 300, and/or the modules in FIG. 4). In some embodiments, the instructions may be transmitted in a form of electronic current or electrical signals.

As used herein, the subject may refer to any composition of organic and/or inorganic matters that are with or without life and located on earth. For example, the subject may be any vehicle (e.g., car, boat, or aircraft) or any person. In certain embodiments, the subject may be an autonomous vehicle (e.g., the vehicle 110) as described elsewhere in the present disclosure (e.g., FIG. 1A and the relevant descriptions). In some embodiments, the pose of the subject may include a position and/or an orientation of the subject in a predetermined coordinate system. The coordinate system may be any suitable coordinate system with a fixed origin and/or one or more fixed axis, such as a standard coordinate system for the Earth. The coordinate system may have any number (or count) of dimensions. For example, the coordinate system may be 2-dimensional (2D) or a 3D coordinate system.

In certain embodiments, the position of the subject in the coordinate system may be represented as a coordinate of the subject in the coordinate system. The orientation of the subject may be represented as one or more Euler angles in the coordinate system. Taking a 3D coordinate system having an X-axis, a Y-axis, and a Z-axis as an example, the position of the subject in the 3D coordinate system may be represented as one or more of an X-coordinate on the X-axis, a Y-coordinate on the Y-axis, and a Z-coordinate on the Z-axis. The orientation of the subject with respect to the 3D coordinate system may be represented as one or more of a yaw angle, a pitch angle, and/or a roll angle.

In some embodiments, the subject may be located in a surrounding environment. The surrounding environment of the subject may refer to the circumstances and one or more objects (including living and non-living objects) surrounding the subject. The surrounding environment may cover an area having any size and shape. In certain embodiments, the area covered by the surrounding environment may be associated with the performance of a sensor (e.g., the sensor(s) 112) assembled on the subject. Taking an autonomous vehicle as an example, a surrounding environment of the autonomous vehicle may include one or more objects around the autonomous vehicle, such as a ground surface, a lane marking, a building, a pedestrian, an animal, a plant, one or more other vehicles, or the like. The size of an area covered by the surrounding environment of the autonomous vehicle may depend (or partially depend) on a scanning range of a LiDAR device assembled on the autonomous vehicle.

Particularly, in certain embodiments, the subject may be located in a path (e.g., the path 116 as shown in FIG. 1B) in the surrounding environment. The path may have a ground surface and one or more curb(s). Each of the curb(s) may be on a side of the path and have a height with respect to the ground surface. For example, the path may have two curbs on two sides of the path. The processing device 122 may perform the process 500 to determine the pose of the subject by analyzing the curb(s) in the surrounding environment.

In 510, the processing device 122 (e.g., the identification module 410) (e.g., the processing circuits of the processor 220) may identify a plurality of sets of data points representing a plurality of cross sections of the path from point-cloud data representative of the surrounding environment.

As used herein, a cross section of the path may refer to a plane surface formed by cutting across the path. In some embodiments, the cross sections of the path may be perpendicular to the ground surface of the path and distributed along a first reference direction associated with the subject. For illustration purposes, it is assumed that the point-cloud data is acquired at a certain time point (or period) when the subject is located at a certain location on the path. In some embodiments, the first reference direction may be an estimated heading direction of the subject at the certain time point (or during the certain time period). The estimated heading direction may be measured by an IMU or a radar unit mounted on the subject, or be determined based on an image acquired by a camera mounted on the subject. In some other embodiments, the first reference direction may be an extension direction of the path at the certain location on the path. The extension direction of the path may be determined based on, for example, an estimated location of the subject, an image acquired by a camera mounted on the subject, etc. In certain embodiments, the plurality of cross sections of the path may be distributed evenly or unevenly along the first reference direction. For example, the distance between each pair of adjacent cross sections along the first reference direction may be a constant value such that the cross sections are distributed evenly along the first reference direction.

In some embodiments, the point-cloud data may be acquired by a sensor (e.g., the sensor(s) 112) assembled on the subject, such as one or more LiDAR devices as described elsewhere in the present disclosure (e.g., FIG. 1A, and descriptions thereof). For example, the sensor may emit laser pulses to scan the surrounding environment. The laser pulses may be reflected by physical points in the surrounding environment and return to the sensor. The sensor may generate the point-cloud data representative of the surrounding environment based on one or more characterizes of the return laser pulses. In certain embodiments, the point-cloud data may be collected during a time period (e.g., 1 second, 2 seconds) when the subject (e.g., the vehicle 110) stops on or travels along a road. In the collection of the point-cloud data, the sensor may rotate in a scanning angle range (e.g., 360 degrees, 180 degrees, 120 degrees) and scan the surrounding environment in a certain scan frequency (e.g., 10 Hz, 15 Hz, 20 Hz).

The point-cloud data may include a plurality of data points, each of which may represent a physical point (e.g., a physical point on the body surface of an object) in the surrounding environment. Each data point may include one or more feature values of one or more features of the corresponding physical point. Exemplary features of a physical point may include a relative position of the physical point with respect to the sensor (or the subject), an intensity of the physical point, a classification of the physical point, a scan direction associated with the physical point, or the like, or any combination thereof. In certain embodiments, the relative position of the physical point may be denoted as a coordinate of the physical point in a coordinate system associated with the sensor (or the subject), such as a coordinate system whose origin is located at the sensor (or the subject). The intensity of the physical point may refer to a strength of returned laser pulse(s) that are reflected by the physical point. The intensity of the physical point may be associated with a property (e.g., the composition and/or material) of the physical point. The classification of the physical point may refer to a type of an object (e.g., ground, water) that the physical point belongs. The scan direction associated with the physical point may refer to the direction in which a scanning mirror of the sensor was directed to when the corresponding data point was detected by the sensor.

The plurality of sets of data points representative of the cross sections may be extracted from the point-cloud data. For example, the processing device 122 may classify the point-cloud data into a plurality of subgroups, each of which represents a physical object. Exemplary physical objects may include but are not limited to the curb(s), the ground surface, a pedestrian, a vehicle, a plant, a lane marking, etc. In some embodiments, each data point collected by the sensor may record a classification of the corresponding physical point as described above. The processing device 122 may classify the point-cloud data based on the classifications of the physical points recorded in the data points. In some other embodiments, the processing device 122 may use a classification model to classify the point-cloud data. Exemplary classification models may include but are not limited to a K-nearest neighbors (KNN) classification model, a Bayesian classification model, a Decision Tree classification model, a Random Forest classification model, a Support Vector Machine (SVM) classification model, a Convolutional Neural Networks (CNN) model, a deep learning model, or the like, or any combination thereof. In some embodiments, the classification model may be trained in advance by the processing device 122 or another computing device using sample data points (e.g., a plurality of data points have known classifications), and stored in a storage device of the autonomous driving system 100A or an external source. The processing device 122 may obtain the classification model from the storage device or the external source. The processing device 122 may further input the point-cloud data into the classification model to classify the point-cloud data.

After the point-cloud data is classified into the sub-groups, the processing device 122 may identify the sets of data points representing the cross sections from the subgroups representing the curb(s) and the ground surface. Merely by way of example, each data point may record a relative position of the corresponding physical point with respect to the sensor as described above. The processing device 122 may identify, from the subgroups representing the curb(s) and the ground surface, certain data points representing a plurality of physical points that are located in a certain cross section based on the relative positions of the physical points. The certain data points may be identified as the set of data points corresponding to the certain cross section.

In 520, the processing device 122 (e.g., the feature vector determination module 420) (e.g., the processing circuits of the processor 220) may determine a feature vector of the curb(s) based on the plurality of sets of data points. The feature vector of the curb(s) may include one or more characteristic values of the curb(s).

In some embodiments, for each cross section of the path, the processing device 122 may determine one or more characteristic values of the curb(s) in the cross section based on the set of data points representative of the cross section. The processing device 122 may further construct the feature vector of the curb(s) based on the one or more characteristic values of the curb(s) in each cross section. In certain embodiments, the cross sections of the path, distributed along the first reference direction, may represent a portion of the path in a 3D space. The feature vector that is constructed based on the characteristic value(s) of the curb(s) in each cross section may then represent feature(s) of the curb(s) in the 3D space. Compared with a feature vector representing feature(s) of the curb(s) in a 2D space (e.g., in a single cross section of the path), the feature vector disclosed herein can more accurately reflect the feature(s) of the curb(s), thereby improving positioning accuracy and efficiency.

In certain embodiments, the curb(s) in a cross section may include a plurality of physical points in the cross section. The one or more characteristic values of the curb(s) in the cross section may include one or more characteristic value(s) related to one or more features of the corresponding physical points. The features of the corresponding physical points may be encoded in the point-cloud data or be determined by the processing device 122. Taking the cross section 100B in FIG. 1B as an example, the left and right curbs in the cross section 100B may include a plurality of physical points (e.g., the physical points a, b, c, d, and the like) in the cross section 100B. For illustration purposes, the plurality of physical points of the left and right curbs in the cross section 100B are referred to as physical points Setₐ. The one or more characteristic values of the left and right curbs may include one or more characteristic values related to one or more features of the physical points Setₐ. The feature(s) of the physical points Setₐ may include a normal angle, an intensity, an elevation, an incidence angle, or the like, or any combination thereof. As used herein, an elevation of a physical point may refer to a height of the physical point above or below a fixed reference point, line, or plane, such as the ground surface 115, the sensor mounted on the subject. In some embodiments, the elevation of each physical point in the Setₐ may be determined based on the relative position of each physical point with respect to the sensor encoded in the corresponding data point.

In some embodiments, the characteristic value(s) related to a feature of the physical points Setₐ may include a characteristic value indicating an overall level of the feature of the physical points Setₐ and/or a characteristic value indicating a distribution of the feature of the physical points Setₐ. Taking the elevation as an exemplary feature, the characteristic value(s) related to the elevations of the physical points Setₐ may include a first characteristic value indicating an overall elevation of the physical points Setₐ and/or a second characteristic value indicating an elevation distribution the physical points Setₐ. The first characteristic value may include a mean elevation, a median elevation, or any other parameter that can reflect the overall elevation of the physical points Setₐ. The second characteristic value may include a covariance, a variance, a standard deviation, a histogram, or any other parameter that can reflect the elevation distribution of the physical points Setₐ. In some embodiments, the characteristic value(s) related to the elevations of the physical points Setₐ may include the histogram of the elevations of the physical points Setₐ, which has an X-axis representing different values (or ranges) of the elevations and an Y-axis representing the number (or count) of physical points in Setₐ corresponding to each value (or ranges) of the elevations.

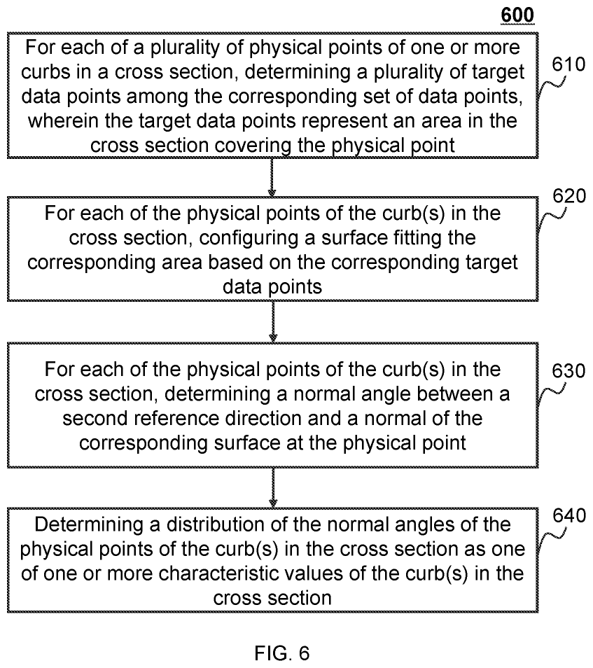

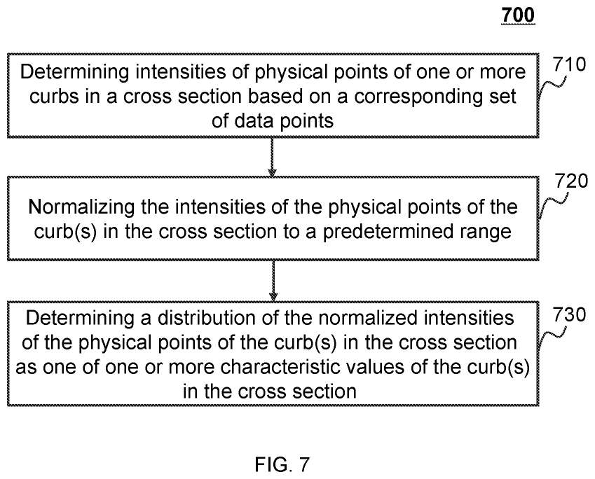

In some embodiments, the characteristic value related to the normal angles of the physical points Setₐ may be determined by performing one or more operations of process 600 as described in connection with FIG. 6. The characteristic value related to the intensities of the physical points Setₐ may be determined by performing one or more operations of process 700 as described in connection with FIG. 7. The characteristic value related to the elevations of the physical points Setₐ may be determined on an elevation of each physical points in Setₐ. The characteristic value related to the incidence angles of the physical points Setₐ may be determined based on an incidence angle of each physical point in the Setₐ.

In 530, the processing device 122 (e.g., the feature vector determination module 420) (e.g., the processing circuits of the processor 220) may determine at least one reference feature vector of the curb(s) based on an estimated pose of the subject and a location information database.

The estimated pose of the subject may be obtained from one or more positioning devices assembled on the subject or be determined based on pose data of the subject acquired by the positioning device(s). For example, the subject may be a vehicle 110 as described in connection with FIG. 1A, the GPS device in combination with the IMU sensor mounted on the vehicle 110 may provide real-time pose data, such as an estimated position and an estimated orientation of the vehicle 110 as it travels. The processing device 122 may obtain the estimated position and/or the estimated orientation from the GPS device and/or the IMU sensor, and designate the estimated position and/or the estimated orientation as the estimated pose of the subject.

The location information database may include any database that includes location information of a region (a country or city) covering the surrounding environment of the subject. In some embodiments, the location information database may be a local database in the autonomous driving system 100A, for example, be a portion of the storage device 140, the ROM 230, and/or the RAM 240. Additionally or alternatively, the location information database may be a remote database, such as a cloud database, which can be accessed by the processing device 122 via the network 150.

In some embodiments, the location information database may store reference point-cloud data representative of the region (e.g., in the form of an HD map of the region). The reference point-cloud data may include a plurality of reference data points, each of which represents a reference physical point in the region and record one or more feature values the corresponding reference physical point. In certain embodiments, at least a portion of the reference point-cloud data may be previously acquired by a sensor mounted on a sample subject. For example, a survey vehicle (e.g., a vehicle 110) may be dispatched for a survey trip to scan the region. As the survey vehicle moves in the region, one or more sensors with high accuracy (e.g., a LiDAR device) installed in the survey vehicle may detect the reference physical points in a surrounding environment of the survey vehicle and acquire the reference point-cloud data. Additionally or alternatively, at least a portion of the reference point-cloud data may be determined based on the information acquired by the survey vehicle, or be inputted and/or verified by a user.

The processing device 122 may determine the at least one reference feature vector of the curb(s) based on the reference point-cloud data and the estimated pose of the subject. For example, the processing device 122 may determine a plurality of hypothetic poses of the subject based on the estimated pose of the subject. A hypothetic pose of the subject may include a hypothetic position and/or a hypothetic orientation of the subject. In certain embodiments, the hypothetic position may be a position near the estimated position of the subject, for example, a position located within a threshold distance to the estimated position. The hypothetic orientation may be an orientation similar to the estimated orientation of the subject. Merely by way of example, the estimated pose of the subject may be represented by one or more estimated Euler angles, and hypothetic orientation may be represented by one or more hypothetic Euler angles. The angle difference between the hypothetic Euler angle(s) and the estimated Euler angle(s) may be smaller than an angle threshold, indicating that the hypothetic orientation is similar to the estimated orientation.

In some embodiments, the processing device 122 may use a particle filtering technique in the process 500 to determine a pose of the subject. The particle filter technique may utilize a set of particles (also referred to as samples), each of which presents a hypothetic pose of the subject and has a weight (or probability) assigned to the particle. The weight of a particle may represent a probability that the particle is an accurate representation of an actual pose of the subject. The particles may be updated (e.g., resampled) iteratively according to an observation of the subject until a certain condition is met. The actual pose of the subject may then be determined based on the updated particles after the condition is met. In operation, the processing device 122 may determine the hypothetic poses of the subject based the estimated pose by distributing a plurality of particles (which represents the hypothetic pose) around the subject (or the estimated location of the subject) in the surrounding environment. In some embodiments, the particles may be uniformly and randomly distributed around the subject. Alternatively, the particles may be nonuniformly distributed around the subject. For example, the processing device 122 may distribute more particles around the curb(s) than on the ground surface.

After the hypothetic poses are determined, for each hypothetic pose, the processing device 122 may obtain a plurality of sets of reference data points representing a plurality of reference cross sections of the path from the location information database. The reference cross sections may be perpendicular to the ground surface and distributed along a third reference direction associated with the hypothetic pose. As used herein, the third reference direction may be a heading direction of the subject when the subject is under the hypothetic pose. Alternatively, the third reference direction may be an extension direction of the path when the subject is under the hypothetic pose. In some embodiments, the reference cross sections on the path and the corresponding sets of data points may be determined in advance and stored the location information database. The processing device 122 may directly obtain the sets of reference data points representative of the reference cross sections from the location information database. Alternatively, the processing device 122 may identify the sets of reference data points from the reference point-cloud data by performing a similar manner with identifying the sets of data points representative of the cross sections from the point-cloud data as described in connection with operation 510.

For each hypothetic pose, the processing device 122 may further determine a reference feature vector of the curb(s) based on the corresponding sets of reference data points. Taking a hypothetic pose as an example, in some embodiments, the processing device 122 may determine one or more reference characteristic values of the curb(s) in each corresponding reference cross section based on the corresponding set of reference data points. The processing device 122 may then construct the reference feature vector corresponding to the hypothetic pose using the reference characteristic value(s) of the curb(s) in the corresponding reference cross sections. The reference characteristic value(s) of the curb(s) in a reference cross section may be similar to the characteristic value(s) of the curb(s) in a cross section as described in connection with operation 520. For example, in each reference cross section, the curb(s) may include a plurality of reference physical points in the reference cross section. The reference characteristic value(s) of the curb(s) in each reference cross section may include a reference characteristic value related to normal angles of the corresponding reference physical points, a reference characteristic value related to intensities of the corresponding reference physical points, a reference characteristic value related to elevations of the corresponding reference physical points, or a reference characteristic value related to incidence angles of the corresponding reference physical points, or the like, or any combination thereof. The reference characteristic value(s) of the curb(s) in a reference cross section may be determined in a similar manner with the characteristic value(s) of the curb(s) in a cross section as described in connection with operation 520, and the descriptions thereof are not repeated here.

In some embodiments, the location information database may store the reference feature vectors of the curb(s) corresponding to the hypothetic poses. The processing device 122 may directly obtain the reference feature vectors from the location information database. Merely by way of example, the location information database may store a plurality of reference feature vectors of the curb(s) corresponding to a plurality of possible hypothetic poses of the subject on the path. The processing device 122 may identify a possible hypothetic pose that is similar to the estimated pose of the subject, and designate the possible hypothetic pose as a certain hypothetic pose of the subject. The processing device 122 may also designate the reference feature vector of the identified possible hypothetic pose as the reference feature vector of the curb(s) corresponding to the certain hypothetic pose.

In 540, the processing device 122 (e.g., the pose determination module 430) (e.g., the processing circuits of the processor 220) may determine the pose of the subject by updating the estimated pose of the subject. The updating of the estimated pose may include comparing the feature vector with the at least one reference feature vector of the curb(s).

In some embodiments, as described in connection with operation 530, the at least one reference feature vector may include a plurality of reference feature vector corresponding to a plurality of hypothetic poses of the subject. The processing device 122 may determine a similarity degree between the feature vector and each of the reference feature vectors. The processing device 122 may further update the estimated pose based on the similarity degrees. In certain embodiments, the processing device 122 may determine the pose of the subject by performing one or more iterations as described in connection with FIG. 8.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described above is not intended to be limiting. For example, operation 520 and operation 530 may be operated simultaneously or operation 530 may be performed before operation 520. In some embodiments, process 500 may further include a storing operation. Any intermediate result, e.g., the plurality of data points, the plurality of sets of data points, the feature vector of the curb(s), etc., may be stored in a storage device (e.g., the storage device 140, the ROM 230, the RAM 240).

FIGS. 6 and 7 are flowcharts illustrating exemplary processes for determining a characteristic value of one or more curbs in a cross section of a path according to some embodiments of the present disclosure. At least a portion of process 600 and/or process 700 may be implemented on the computing device 200 as illustrated in FIG. 2. In some embodiments, one or more operations of the process 600 and/or the process 700 may be implemented in the autonomous driving system 100A as illustrated in FIG. 1A. In some embodiments, one or more operations in the process 600 and/or the process 700 may be stored in a storage device (e.g., the storage device 140, the ROM 230, the RAM 240) as a form of instructions, and invoked and/or executed by the processing device 122 (e.g., the processor 220 of the computing device 200, the CPU 340 of the mobile device 300, and/or the modules in FIG. 4).

In some embodiments, the curb(s) in the cross section may include a plurality of physical points in the cross section. The process 600 may be performed to determine a characteristic value related to normal angles of the plurality of physical points. The process 700 may be performed to determine a characteristic value related to intensities of the plurality of physical points. In some embodiments, the process 600 and/or the process 700 may be performed for each of the cross sections of the path identified in operation 510 to determine one or more characteristic values of the curb(s) in each cross section. The characteristic value(s) of the curb(s) in each cross section may be used in the construction of the feature vector of the curb(s) as described in operation 520.

In 610, for each physical point of the curb(s) in the cross section, the processing device 122 (e.g., the feature vector determination module 420) (e.g., the processing circuits of the processor 220) may determine a plurality of target data points among the corresponding set of data points, wherein the target data points may represent an area in the cross section covering the physical point. In some embodiments, for a certain physical point, the determined target data points may represent a plurality of target physical points on the cross section that are close to the certain physical point.

In 620, for each physical point of the curb(s) in the cross section, the processing device 122 (e.g., the feature vector determination module 420) (e.g., the processing circuits of the processor 220) may configure a surface fitting the corresponding area based on the corresponding target data points. For a certain physical point, the surface fitting the corresponding area may be a flat surface, a curved surface, an irregular surface, etc. In some embodiments, the target data points corresponding to the certain physical point may include position information of the target physical points close to the certain physical point. The surface fitting the corresponding area of the certain physical point may be determined based on the position information of the target physical points according to a surface fitting algorithm.

In 630, for each physical point of the curb(s) in the cross section, the processing device 122 (e.g., the feature vector determination module 420) (e.g., the processing circuits of the processor 220) may determine a normal angle between a second reference direction and a normal of the corresponding surface at the physical point. As used herein, the second reference direction may be any fixed direction. For example, the second reference direction may be parallel with or perpendicular to the ground surface of the path.

In 640, the processing device 122 (e.g., the feature vector determination module 420) (e.g., the processing circuits of the processor 220) may determine a distribution of the normal angles of the physical points of the curb(s) in the cross section as one of one or more characteristic values of the curb(s) in the cross section.

In some embodiments, the distribution of the normal angles of the physical points of the curb(s) in the cross section may be represented by a covariance, a variance, a standard deviation, and/or a histogram of the normal angles. In certain embodiments, the distribution of the normal angles may be represented by the histogram of the normal angles. The histogram of the normal angles may include an X-axis and a Y-axis, wherein the X-axis may represent different values (or ranges) of the normal angles and the Y-axis may represent the number (or count) of physical points in the cross section corresponding to each value (or range) of the normal angles.

In 710, the processing device 122 (e.g., the feature vector determination module 420) (e.g., the processing circuits of the processor 220) may determine intensities of the physical points of curb(s) in the cross section based on the corresponding set of data points representative of the cross section.

As described in connection with operation 520, each data point in the point-cloud data acquired by the sensor mounted on the subject may represent a physical point in the surrounding environment and encode an intensity of the corresponding physical point. For each physical point of the curb(s) in the cross section, the processing device 122 may determine an intensity of the physical point based on the corresponding data point in the set of data points representative of the cross section.

In 720, the processing device 122 (e.g., the feature vector determination module 420) (e.g., the processing circuits of the processor 220) may normalize the intensities of the physical points of the curb(s) in the cross section to a predetermined range.

In some embodiments, different sensors may have different settings. For example, the sensor that acquires the point-cloud data representative of the surrounding may determine an intensity of a physical point in a range of [1, 256] based on returned laser pulse(s) that are reflected by the physical point. A sensor that acquires the reference point-cloud data stored in the location information database may determine the intensity of the physical point in another range, such as [0, 255]. Thus, the processing device 122 may need to normalize the intensities of the physical points of the curb(s) in the cross section to the predetermined range to avoid a mismatch between the point-cloud data and the reference point-cloud data.

In some embodiments, the predetermined range may be any suitable range, such as [0, 255], [1, 256], [2, 257], or the like. The predetermined range may be a default setting of the autonomous driving system 100A, be set manually by a user, or be determined by the autonomous driving system 100A according to different situations.

In 730, the processing device 122 (e.g., the feature vector determination module 420) (e.g., the processing circuits of the processor 220) may determine a distribution of the normalized intensities of the physical points of the curb(s) in the cross section as one of one or more characteristic values of the curb(s) in the cross section.

In some embodiments, the distribution of the normalized intensities of the physical points of the curb(s) in the cross section may be represented by a covariance, a variance, a standard deviation, and/or a histogram of the normalized intensities. In certain embodiments, the distribution of the normalized intensities may be represented by the histogram of the normalized intensities. The histogram of the normalized intensities may include an X-axis and a Y-axis, wherein the X-axis may represent different values (or ranges) of the normalized intensities and the Y-axis may represent the number (or count) of physical points in the cross section corresponding to each value (or range) of the normalized intensities.

It should be noted that the above descriptions regarding the processes 600 and 700 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. The operations of the illustrated process present below are intended to be illustrative. In some embodiments, the processes 600 and 700 may be accomplished with one or more additional operations not described and/or without one or more of the operations herein discussed. Additionally, the order in which the operations of the processes 600 and 700 described above is not intended to be limiting.

In some embodiments, the processing device 122 may determine one or more other characteristic values related to the normal angles and/or the intensities of the physical points of the curb(s) in the cross section, and designate the one or more other characteristic values as one or more characteristic values of the curb(s) in the cross section. Taking the normal angles as an example, the processing device 122 may determine a mean or median normal angle of the physical points of the curb(s) in the cross section as a characteristic value of the curb(s) in the cross section. In some embodiments, in the process 700, operation 720 may be omitted and the processing device 122 may determine the distribution of the intensities of the physical points of the curb(s) in the cross section as one of the characteristic value(s) of the curb(s) in the cross section.

FIG. 8 is a flowchart illustrating an exemplary process for determining a pose of a subject according to some embodiments of the present disclosure. In some embodiments, one or more operations of process 800 may be implemented in the autonomous driving system 100A as illustrated in FIG. 1A. For example, one or more operations in the process 800 may be stored in a storage device (e.g., the storage device 140, the ROM 230, the RAM 240) as a form of instructions, and invoked and/or executed by the processing device 122 (e.g., the processor 220 of the computing device 200, the CPU 340 of the mobile device 300, and/or the modules in FIG. 4). When executing the instructions, the processing device 122 may be configured to perform the process 800.

In some embodiments, one or more operations of the process 800 may be performed to achieve at least part of operation 540 as described in connection with FIG. 5. In certain embodiments, the at least one reference feature vector of the curb(s) determined in operation 530 may include a plurality of reference feature vector corresponding to a plurality of hypothetic poses of the subject. The process 800 may perform one or more iterations to determine the pose of the subject based on the feature vector of the curb(s) (determined in 520) and the reference feature vectors corresponding to the hypothetic poses. In the iteration(s), the estimated pose of the subject, the hypothetic poses of the subject, and/or the reference feature vectors of the curb(s) corresponding to the hypothetic poses may be updated. For illustration purposes, a current iteration of the process 800 is described. The current iteration may include one or more of the operations as shown in FIG. 8.

In 810, for each hypothetic pose of the subject in the current iteration, the processing device 122 (e.g., the pose determination module 430) (e.g., the processing circuits of the processor 220) may determine a similarity degree between the feature vector and the corresponding reference feature vector.

Taking a certain hypothetic pose in the current iteration as an example, the corresponding similarity degree may be configured to measure a difference or similarity between the feature vector and the corresponding reference feature vector. The similarity degree between the feature vector and the corresponding reference feature vector may be measured by, for example, a vector difference, a Pearson correlation coefficient, a Euclidean distance, a cosine similarity, a Tanimoto coefficient, a Manhattan distance, a Mahalanobis distance, a Lance Williams distance, a Chebyshev distance, a Hausdorff distance, etc. In some embodiments, the processing device 122 may determine a vector difference to measure the difference between the corresponding reference feature vector and the feature vector. The processing device 122 may further determine the similarity degree corresponding to the certain hypothetic pose based on the vector difference. For example, the similarity degree corresponding to the certain hypothetic pose may have a negative correlation with the vector difference. In some embodiments, the processing device 122 may determine a value of a cost function to measure the difference between the corresponding reference feature vector and the feature vector. The processing device 122 may further determine the similarity degree corresponding to the certain hypothetic pose based on the value of the cost function. For example, the similarity degree corresponding to the certain hypothetic pose may have a negative correlation with the value of the cost function.

In 820, the processing device 122 (e.g., the pose determination module 430) (e.g., the processing circuits of the processor 220) may determine a probability distribution over the plurality of hypothetic poses in the current iteration based on the similarity degrees in the current iteration.

The probability distribution over the hypothetic poses in the current iteration may include a probability determined for each hypothetic pose in the current iteration. The probability of a hypothetic pose may represent a probability that the hypothetic pose is an accurate representation of an actual pose of the subject. In some embodiments, the probability of a hypothetic pose may have a positive correlation with the similarity degree between the feature vector and the corresponding reference feature vector. For example, it is assumed that a similarity degree between the feature vector and a reference feature vector corresponding to a first hypothetic pose is S1, and a similarity degree between the feature vector and a reference feature vector corresponding to a second hypothetic pose is S2. The processing device 122 may assign a higher probability to the first hypothetic pose than the second hypothetic pose if S1 is greater than S2.

In some embodiments, as described in connection with FIG. 5, the processing device 122 may determine the pose of the subject according to a particle filtering technique. Each hypothetic pose in the current iteration may be represented by a particle in the current iteration. The probability of a hypothetic pose in the current iteration may also be referred to as a weight of the corresponding particle in the current iteration.

In 830, the processing device 122 (e.g., the pose determination module 430) (e.g., the processing circuits of the processor 220) may update an estimated pose of the subject in the current iteration based on the hypothetic poses and the probability distribution in the current iteration.

In some embodiments, the updated estimated pose in the current iteration may be a weighted sum of the hypothetic poses in the current iteration. For example, the updated estimated pose in the current iteration may be determined according to Equation (1) as below:

Ê=Σⱼ₌₀^{M}P^{j}*H^{j} (1),

where Ê refers to the updated estimated pose in the current iteration, M refers to the total number (or count) of the hypothetic poses in the current iteration, P^{j} refers to a probability corresponding to a j^{th} hypothetic pose in the current iteration, and H^{j} refers to the j^{th} hypothetic pose in the current iteration.

In 840, the processing device 122 (e.g., the pose determination module 430) (e.g., the processing circuits of the processor 220) may determine whether a termination condition is satisfied in the current iteration. An exemplary termination condition may be that the difference between the estimated pose and the updated estimated pose in the current iteration is within a threshold, indicating the estimated pose converges. Other exemplary termination conditions may include that a certain count of iterations are performed, that a difference between the hypothetic poses (or particles) in the current iteration and the hypothetic poses (or particles) in the previous iteration is within a threshold such that the hypothetic poses (or particles) of current iteration converges, an overall similarity degree (e.g., a mean similarity degree) corresponding to the hypothetic poses in the current iteration exceeds a threshold, etc.

In response to a determination that the termination condition is satisfied, the process 800 may proceed to 880. In 880, the processing engine 122 (e.g., the pose determination module 430) (e.g., the processing circuits of the processor 220) may designate the updated estimated pose in the current iteration as the pose of the subject.

On the other hand, in response to a determination that the termination condition is not satisfied, the process 800 may proceed to operations 850 to 870.

In 850, the processing device 122 (e.g., the pose determination module 430) (e.g., the processing circuits of the processor 220) may update the plurality of hypothetic poses.

In some embodiments, the processing device 122 may update the hypothetic poses by resampling. For example, the processing device 122 may remove one or more hypothetic poses (or particles) if their probabilities (or weights) determined in the current iteration are smaller than a first threshold. As another example, the processing device 122 may replicate one or more hypothetic poses (or particles) if their probabilities (or weights) determined in the current iteration are greater than a second threshold. In certain embodiments, the processing device 122 may update a hypothetic pose (or particles) in the current iteration by updating the hypothetic position and/or hypothetic orientation of the subject defined by the hypothetic pose. Merely by way of example, the processing device 122 may determine an updated possible position and/or orientation of the subject as an updated hypothetic pose of the subject.

In some embodiments, the processing device 122 may determine an adjustment value of a hypothetic pose, and further determine a corresponding updated hypothetic pose based on the adjustment value and the hypothetic pose. For example, in certain embodiments, the similarity degree between the feature vector and the reference feature vector of the hypothetic pose in the current iteration may be determined based on a cost function as described above. The cost function may be a non-linear function of the hypothetic pose, wherein the hypothetic pose may be denoted as a and the cost function may be denoted as F(a). An equation (2) may be derived by expending F(a) at a₀ using the Taylor expansion as below:

F(a)=F(a₀)+JΔa (2),

where a₀ refers to the estimated pose of the subject determined in operation 530, J refers to the first derivative of F(a), and Δa refers to an adjustment value of the hypothetic pose a.

The adjustment value Δa may be determined based on the Equation (2) and a least square algorithm as illustrated in Equation (3) as below:

Δa=(J^{T}J)⁻¹J^{T}(Z−F(a′ᵢ)) (3),

where Z refers to the feature vector of the curb(s) determined in operation 520, F(a′ᵢ) refers to a value of the cost function for the hypothetic pose a in the i^{th} iteration (e.g., the current iteration). In some embodiments, the updated hypothetic pose may be equal to a sum of the hypothetic pose a and Δa.

In 860, for each updated hypothetic pose of the subject in the current iteration, the processing device 122 (e.g., the pose determination module 430) (e.g., the processing circuits of the processor 220) may determine an updated reference feature vector of the curb(s) in the current iteration.

The updated reference feature vector of the curb(s) corresponding to an update hypothetic pose may be determined in a similar manner with a reference feature vector of the curb(s) corresponding to a hypothetic pose as described in connection with operation 530. For example, for each updated hypothetic pose, the processing device 122 may determine a plurality of sets of reference data points representative of a plurality of reference cross sections based on the location information database. The processing device 122 may further determine the updated reference feature vector of the curb(s) based on the corresponding sets of reference data points.

In 870, the processing device 122 (e.g., the pose determination module 430) (e.g., the processing circuits of the processor 220) may designate the updated hypothetic poses in the current iteration as the hypothetic poses in a next iteration. The processing device 122 may also designate the updated reference feature vectors as the reference feature vectors corresponding to the hypothetic poses in the next iteration. After operations 840 to 870, the process 800 may proceed to operation 810 again to perform the next iteration until the termination condition is satisfied.

It should be noted that the above descriptions regarding the process 800 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 800 may be accomplished with one or more additional operations not described and/or without one or more of the operations discussed. For example, the process 800 may further include an operation to store the pose and/or an operation to transmit the pose to a terminal device associated with the subject (e.g., a built-in computer of the vehicle 110) for presentation. Additionally, the order in which the operations of the process 800 described above is not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “device,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining a pose of a subject, the subject being located on a path in a surrounding environment, the path having a ground surface and at least one curb, each of the at least one curb being on a side of the path and having a height, the system comprising:
at least one storage medium including a set of instructions; and
at least one processor in communication with the at least one storage medium, wherein when executing the instructions, the at least one processor is configured to direct the system to perform operations including:
identifying, from point-cloud data representative of the surrounding environment, a plurality of sets of data points representing a plurality of cross sections of the path, the plurality of cross sections being perpendicular to the ground surface and distributed along a first reference direction associated with the subject;
determining a feature vector of the at least one curb based on the plurality of sets of data points;
determining, based on an estimated pose of the subject and a location information database, at least one reference feature vector of the at least one curb; and
determining the pose of the subject by updating the estimated pose of the subject, wherein the updating of the estimated pose including comparing the feature vector with the at least one reference feature vector.

2. The system of claim 1, wherein to identify the plurality of sets of data points representing the plurality of cross sections of the path, the at least one processor is further configured to direct the system to perform additional operations including:
classifying the point-cloud data into a plurality of subgroups representing a plurality of physical objects, the plurality of physical objects at least including the at least one curb and the ground surface; and
identifying the plurality of sets of data points from the subgroup representing the at least one curb and the subgroup representing the ground surface.

3. The system of claim 2, wherein to classify the point-cloud data into the plurality of subgroups, the at least one processor is further configured to direct the system to perform additional operations including:
obtaining a classification model of data points; and
classifying the point-cloud data into the plurality of subgroups by inputting the point-cloud data into the classification model.

4. The system of claim 1, wherein to determine the feature vector of the at least one curb based on the plurality of sets of data points, the at least one processor is further configured to direct the system to perform additional operations including:
for each cross section of the path, determining one or more characteristic values of the at least one curb in the cross section based on the corresponding set of data points; and
constructing the feature vector of the at least one curb based on the one or more characteristic values of the at least one curb in each cross section.

5. The system of claim 4, wherein the at least one curb in each cross section includes a plurality of physical points in the cross section, and the one or more characteristic values of the at least one curb in each cross section include at least one of a characteristic value related to normal angles of the corresponding physical points, a characteristic value related to intensities of the corresponding physical points, a characteristic value related to elevations of the corresponding physical points, or a characteristic value related to incidence angles of the corresponding physical points.

6. The system of claim 4, wherein for each cross section:
the at least one curb in the cross section includes a plurality of physical points on the cross section, and to determine the one or more characteristic values of the at least one curb in the cross section based on the corresponding set of data points, the at least one processor is further configured to direct the system to perform additional operations including:
for each of the physical points of the at least one curb in the cross section,
determining, among the corresponding set of data points, a plurality of target data points representing an area in the cross section, the area covering the physical point;
configuring a surface fitting the corresponding area based on the corresponding target data points; and
determining a normal angle between a second reference direction and a normal of the corresponding surface at the physical point; and
determining a distribution of the normal angles of the physical points of the at least one curb in the cross section as one of the one or more characteristic values of the at least one curb in the cross section.

7. The system of claim 4, wherein for each cross section:
the at least one curb in the cross section includes a plurality of physical points on the cross section, and to determine the one or more characteristic values of the at least one curb in the cross section based on the corresponding set of data points, the at least one processor is further configured to direct the system to perform additional operations including:
determining intensities of the physical points of the at least one curb in the cross section based on the corresponding set of data points; and
determining a distribution of the intensities of the physical points of the at least one curb in the cross section as one of the one or more characteristic values of the at least one curb in the cross section.

8. The system of claim 7, wherein to determine the distribution of the intensities of the physical points of the at least one curb in the cross section as one of the one or more characteristic values of the at least one curb in the cross section, the at least one processor is further configured to direct the system to perform additional operations including:
normalizing the intensities of the physical points of the at least one curb in the cross section to a predetermined range; and
determining a distribution of the normalized intensities of the physical points of the at least one curb in the cross section as one of the one or more characteristic values of the at least one curb in the cross section.

9. The system of claim 1, wherein the at least one reference feature vector includes a plurality of reference feature vectors, and to determine the at least one reference feature vector of the at least one curb, the at least one processor is further configured to direct the system to perform additional operations including:
determining a plurality of hypothetic poses of the subject based on the estimated pose of the subject;
for each of the plurality of hypothetic poses of the subject, obtaining, from the location information database, a plurality of sets of reference data points representing a plurality of reference cross sections of the path, the plurality of reference cross sections being perpendicular to the ground surface and distributed along a third reference direction associated with the hypothetic pose; and
for each of the hypothetic poses of the subject, determining a reference feature vector of the at least one curb based on the corresponding sets of reference data points.

10. The system of claim 9, wherein the determining the pose of the subject includes one or more iterations, and each current iteration of the one or more iterations includes:
for each of the plurality of hypothetic poses, determining a similarity degree between the feature vector and the corresponding reference feature vector in the current iteration;
determining a probability distribution over the plurality of hypothetic poses in the current iteration based on the similarity degrees in the current iteration;
updating the estimated pose of the subject in the current iteration based on the plurality of hypothetic poses and the probability distribution in the current iteration;
determining whether a termination condition is satisfied in the current iteration; and
in response to a determination that the termination condition is satisfied in the current iteration, designating the updated pose of the subject in the current iteration as the pose of the subject.

11. The system of claim 10, wherein each current iteration of the one or more iterations further includes
in response to a determination that the termination condition is not satisfied in the current iteration, updating the plurality of hypothetic poses in the current iteration;
for each of the updated hypothetic poses in the current iteration, determining an updated reference feature vector of the at least one curb in the current iteration;
designating the plurality of updated hypothetic poses in the current iteration as the plurality of hypothetic poses in a next iteration; and
designating the plurality of updated reference feature vectors in the current iteration as the plurality of reference feature vectors in the next iteration.

12. The system of claim 11, wherein the determining the pose of the subject is performed based on a particle filtering technique.

13. The system of claim 1, wherein the plurality of cross sections of the path are evenly distributed along the first reference direction.

14. The system of claim 1, wherein the pose of the subject includes at least one of a position of the subject or an orientation of the subject.

15. The system of claim 1, wherein the at least one processor is further configured to direct the system to perform additional operations including:
receiving, from at least one positioning device assembled on the subject, pose data of the subject; and
determining the estimated pose of the subject based on the data.

16. A method for determining a pose of a subject, the subject being located on a path in a surrounding environment, the path having a ground surface and at least one curb, each of the at least one curb being on a side of the path and having a height, the method being implemented on a computing device having at least one processor, at least one storage medium, and a communication platform connected to a network, the method comprising:
identifying, from point-cloud data representative of the surrounding environment, a plurality of sets of data points representing a plurality of cross sections of the path, the plurality of cross sections being perpendicular to the ground surface and distributed along a first reference direction associated with the subject;
determining a feature vector of the at least one curb based on the plurality of sets of data points;
determining, based on an estimated pose of the subject and a location information database, at least one reference feature vector of the at least one curb; and
determining the pose of the subject by updating the estimated pose of the subject, wherein the updating of the estimated pose including comparing the feature vector with the at least one reference feature vector.

17. The method of claim 16, wherein the identifying of the plurality of sets of data points representing the plurality of cross sections of the path comprises:
classifying the point-cloud data into a plurality of subgroups representing a plurality of physical objects, the plurality of physical objects at least including the at least one curb and the ground surface; and
identifying the plurality of sets of data points from the subgroup representing the at least one curb and the subgroup representing the ground surface.

18. (canceled)

19. The method of claim 16, wherein the determining of the feature vector of the at least one curb based on the plurality of sets of data points comprises:
for each cross section of the path, determining one or more characteristic values of the at least one curb in the cross section based on the corresponding set of data points; and
constructing the feature vector of the at least one curb based on the one or more characteristic values of the at least one curb in each cross section.

20. The method of claim 19, wherein the at least one curb in each cross section includes a plurality of physical points in the cross section, and the one or more characteristic values of the at least one curb in each cross section include at least one of a characteristic value related to normal angles of the corresponding physical points, a characteristic value related to intensities of the corresponding physical points, a characteristic value related to elevations of the corresponding physical points, or a characteristic value related to incidence angles of the corresponding physical points.

21-30. (canceled)

31. A non-transitory readable medium, comprising at least one set of instructions for determining a pose of a subject, the subject being located on a path in a surrounding environment, the path having a ground surface and at least one curb, each of the at least one curb being on a side of the path and having a height, wherein when executed by at least one processor of an electrical device, the at least one set of instructions directs the at least one processor to perform a method, the method comprising:
identifying, from point-cloud data representative of the surrounding environment, a plurality of sets of data points representing a plurality of cross sections of the path, the plurality of cross sections being perpendicular to the ground surface and distributed along a first reference direction associated with the subject;
determining a feature vector of the at least one curb based on the plurality of sets of data points;
determining, based on an estimated pose of the subject and a location information database, at least one reference feature vector of the at least one curb; and
determining the pose of the subject by updating the estimated pose of the subject, wherein the updating of the estimated pose including comparing the feature vector with the at least one reference feature vector.

32. (canceled)
